(19) United States
(12) Patent Application Publication
(10) Pub. No.: US 2013/0275273 A1
(43) Pub. Date: Oct. 17, 2013

(54) SYSTEM AND METHOD FOR FULFILLING TRANSACTIONS THROUGH ANOTHER USER

(71) Applicant: INDICO INTERACTIVE, INC., San Francisco, CA (US)

(72) Inventors: Michael N. CHAMPLIN, San Francisco, CA (US); David G. CHAMPLIN, San Francisco, CA (US)

(73) Assignee: Indico Interactive, Inc., San Francisco, CA (US)

(21) Appl. No.: 13/857,936

(22) Filed: Apr. 5, 2013

Related U.S. Application Data
(60) Provisional application No. 61/623,474, filed on Apr. 12, 2012.

(51) Int. Cl. G06Q 30/06

(52) U.S. Cl. CPC G06Q 30/0635
USPC 705/26.81

(57) ABSTRACT

One embodiment relates to a transaction system that allows one or more users to purchase or reserve goods or services using electronic computer interfaces and authorizes a receiving user to receive fulfillment of the goods or services. The membership of a shared communication context may be used to determine if the receiving user is authorized to receive fulfillment of the goods or services. Other embodiments, aspects and features are also disclosed.

### CROSS-REFERENCE TO RELATED APPLICATION(S)

The present application claims the benefit of U.S. Provisional Patent Application No. 61/623,474, filed Apr. 12, 2012, the disclosure of which is hereby incorporated by reference.

### BACKGROUND

1. Technical Field

The present invention relates to electronic commerce and mobile communications.

2. Description of the Background Art

People are increasingly shopping online, including via mobile devices and tablet computers, as well as shopping virtually and later visiting a physical store to pick-up items that were purchased previously online. Hence, on-line retail sales continue to increase.

In another growing trend, mobile communication devices, such as smart phones, are increasingly being used for electronic commerce. For example, people shopping in physical stores are communicating via mobile devices with remote friends to discuss the items they are considering purchasing, to gather second opinions, and to confirm instructions and preferences.

### BRIEF DESCRIPTION OF THE DRAWINGS

FIG. 1 illustrates an arrangement of components for a user-associating transaction system that may be used by a remote user to perform a transaction with a business through another user in accordance with an embodiment of the invention.

FIG. 2 shows components of a user-associating transaction server in accordance with an embodiment of the invention.

FIG. 3A is a flow diagram that illustrates the steps of an exemplary process for performing a transaction with a business through another user in accordance with an embodiment of the invention.

FIG. 3B is a flow diagram that illustrates the steps of another exemplary process for performing a transaction with a business through another user in accordance with an embodiment of the invention.

FIG. 4 depicts an example computer apparatus for use in implementing system components in accordance with an embodiment of the invention.

### SUMMARY

Embodiments consistent with the present invention allow one or more users to purchase or reserve goods or services using electronic computer interfaces and authorize a receiving user to receive fulfillment of the goods or services. The membership of a shared communication context may be used to determine if the receiving user is authorized to receive fulfillment of the goods or services.

One embodiment relates to a method of fulfilling a purchase of one or more goods or services through another user. A communication context is established between first and second users using instances of a client software application on electronic computing devices by a user-associating transaction server. The user-associating transaction server records a transaction for a purchase of a first item by the first user. A determination is subsequently made as to whether the first item is authorized to be fulfilled to the second user due to the established communication context between the first and second users.

Another embodiment relates to a user-associating transaction server including at least one processor, a tangible, non-transitory data storage system including memory, a communication system for interconnecting the at least one processor and the data storage system, and a network interface for communicating with a data network. The server includes computer-readable program code stored in the data storage system for (a) establishing a communication context between first and second users using instances of a client software application on electronic computing devices and a user-associating transaction server, (b) recording, at the user-associating transaction server, a transaction for a purchase of a first item by the first user, and (c) determining that the first item is authorized to be fulfilled to the second user due to the established communication context between the first and second users.

Another embodiment relates to a system for performing a transaction through another user. The system includes a user-associating transaction server and a plurality of mobile communication devices executing instances of a client software application.

Other embodiments, aspects and feature are also disclosed.

### DETAILED DESCRIPTION

People often coordinate purchases through each other when one party is in a physical retail location and the other is remote. In a typical scenario, the person in the store will ask the remote party (via a telephone call or text messaging), “Would you like anything from XYZ while I'm here.” The remote party will consider the question, and may request one or more items.

Applicants have determined that conventional electronic commerce and mobile communications systems are lacking in capabilities for performing a transaction with a business through another user, such as a friend. Today, it is difficult for the remote party to both complete a remote purchase directly with the business and enable a friend to pick-up the transacted goods.

In one partial make-shift technique available today, the remote party will manually communicate the list of desired items to the in-store user and the in-store user will pay for the items. Unfortunately, this means that the remote user must later reimburse the in-store user for the purchased items. Also, it means that the business is not able to identify that this transaction originated from the remote user, rather than the in-store user paying for the items.

Alternatively, today, the remote party might be able to send the in-store party a proof-of-purchase that the in-store party could use to pick-up the remotely purchased items. Perhaps simply holding such a proof-of-purchase is sufficient to authorize pick-up for the remotely purchased items. Unfortunately, if the in-store user is picking up for multiple remote parties, the in-store user might have to redeem multiple proofs-of-purchase, a potentially tedious process.

The present application discloses a system and method that enables a remote user to perform a transaction with a business through another user, where the remote user and the other user are associated with each other or “linked” to each other by a shared communication context or other means. In accordance with the system and method disclosed herein, since the remote user's transaction may be associated with the identity of the user picking up, the in-store user may authenticate with the business once and pick-up purchases for multiple remote friends.

Furthermore, since users often exchange messages as part of the process of offering to pick-up, the system and method disclosed herein may be even more useful when the remote transaction is associated with the communication context in which the users are having their related discussion, such as a chat thread or messaging application. In one implementation of this invention, the system associates the transaction with the communication context. The system that authorizes fulfillment of the transaction may use the membership of the communication context to affect pick-up authorization. In one implementation, any member of the communication context is automatically authorized to pick-up goods purchased by any other member of the communication context.

By utilizing the system and method disclosed herein, a business gains an advantageous opportunity to improve its overall user experience and increase economic activity by extending its storefront to the remote party participating in a coordinated purchase. By providing the remote user with an interactive virtual storefront, the user can browse among items, discover items he/she might want, and precisely specify a desired item, which is especially useful when configuring an item such as a customized coffee beverage. Additionally, the retailer may promote items to the remote user, inspiring the user to order an item not previously considered.

In the context of the present application, a “business activity” may be defined as an experience designed by the business, that leads to an outcome or accomplishment that is valuable for the business.

In the context of the present application, an “interactive interface” may be defined as a collection of software and media resources which, when rendered, shows information to the user and may present the user with one or more user interface controls. When selected, the user interface controls may communicate with local or remote systems and communicate their selection and additional information provided by the user. For example, an interactive interface may enable a user to make a selection from a menu of drinks offered by a coffee restaurant. In an exemplary implementation, the user's selection may be communicated from a mobile communication device executing the interactive interface to a user-associating transaction server over the Internet.

In the context of the present application, a “communication context” may be defined as a group of entities associated with a facility for communication. The associated entities are often people (i.e. accounts of identified end users), but could possibly include computerized or machine agents. Communication may include various forms of exchange of information over a network. Examples include, but are not limited to, SMS and MMS messaging, email, instant messaging, social network posting, social network messaging, document or media collaboration, or voice or video conversation. In this definition, the exchanges of information could be real-time or asynchronous.

In other words, a communication context associates a set of users with a set of exchanged messages. In one implementation, a datastore would have a record that describes the communication context. This record includes, among other things, an ID that uniquely identifies the communication context. The set of participants in the communication context might be represented by a collection of records, each of which associates the ID of the communication context and the ID of a user. Additionally, the set of exchanged messages in the communication context might be represented by a collection of records, each of which associates the ID of the communication context with the ID of a message.

The members of the communication context may be established in various ways depending on the implementation. Membership may be defined by specifying a group or by adding members individually. In the case of specifying a group, a group may be specified with an initial member identified with a user ID, and members may be added to a group by adding their user IDs to a membership list. Note that it is possible that a group may be specified that has zero initial members, members being added to the group in the future. As an example of such a group, it is possible that a communication context may be established for the set of users who will occupy a particular conference room at a future time, but that the attendee roster is unknown at the present time. In another case of specifying the members via a group, the group may be an ad hoc group. Examples of ad hoc groups include those that are formed by the members sharing the current location, the members associating their devices together via near field communication, or detecting a shared signal of some form. The set of members of a communication context may vary over time as users are added and removed from the set.

In an example transaction addressed by one embodiment of this invention, User A user offers to pick up a coffee for a remote user, User B, from a retail coffee shop, called Coffee Company. User B uses a smartphone computer device to view Coffee Company's menu and purchase a coffee and a pastry, with the credit card transaction being conducted directly with Coffee Company. User B authorizes user A to pick-up the pre-paid coffee and pastry on his behalf. Later, User A approaches an employee in the Coffee Company location and identifies himself. The employee uses the system to look up any transactions for which User A is authorized to receive fulfillment, and provides User B's coffee and pastry to User A. User A later delivers User B's purchases to User B.

In one embodiment of the invention, the server system associates the transaction for the coffee and pastry with a communication context shared by Users A and B. The communication context might include messages between Users A and B as they discuss purchasing items from Coffee Company. The system may refer to the membership of the communication context to establish the pick-up authorization. In this example, any member of the communication context might be authorized to pick up the coffee and pastry.

In this example, the transaction involved the purchase of a physical good to be fulfilled at a physical store location in which a human employee participates in the fulfillment step. The invention disclosed herein also addresses transactions of other types, including fulfillment in a physical location, but that is completed by an automated fulfillment system, such as an automated ticket printing kiosk. The transaction might also involve the purchase of an item to be redeemed or fulfilled electronically. For example, User A might purchase the rental of a digital content item such as a movie and user B might be authorized to consume the media. Alternatively, the transaction might instead involve the reservation of a good or service instead of a purchase. For example, User A might reserve a ticket for an assigned seat at a free concert and User B might be authorized to pick-up User A's ticket at the physical concert venue.

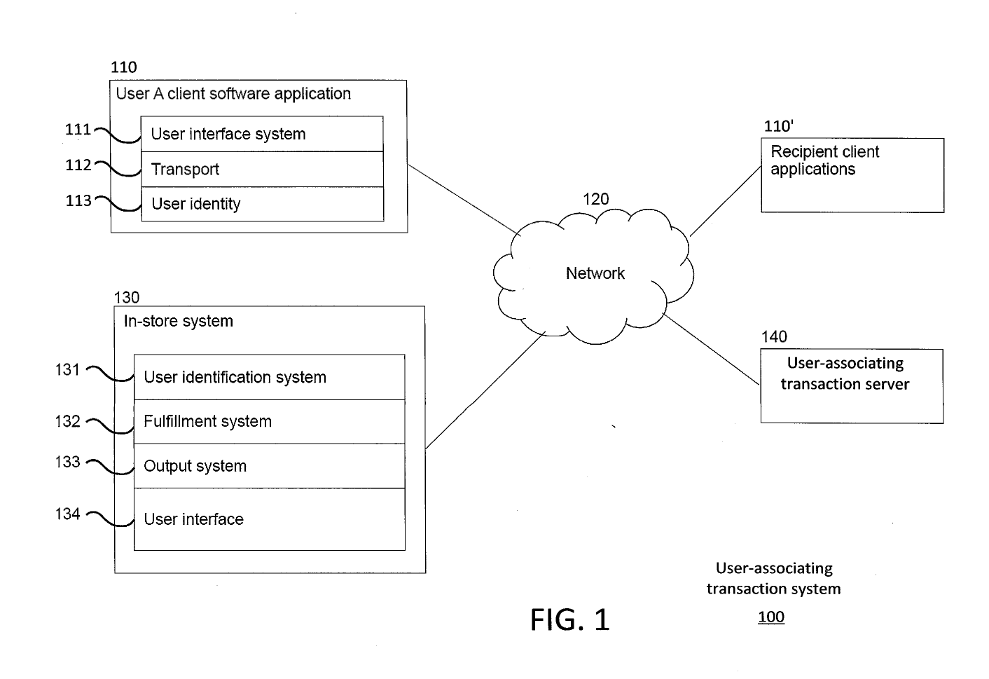

FIG. 1 illustrates an arrangement of components for a user-associating transaction system (100) that may be used by one or more remote users to perform a transaction with a business through another user in accordance with an embodiment of the invention. Each user has a computer, which may be a mobile computing device, such as a smart phone.

The user who is at the location for transacting the business activity (e.g., the user at the in-store location) may run a client software application (110) on his/her computer device. The client software application may be implemented as web pages and scripts rendered in a browser. The client software application may alternatively be implemented as a native application. The client software application may be used on a variety of computer systems, like a smartphone, a tablet computer, a laptop or other computer, an Internet-connected television, a video game console, etc.

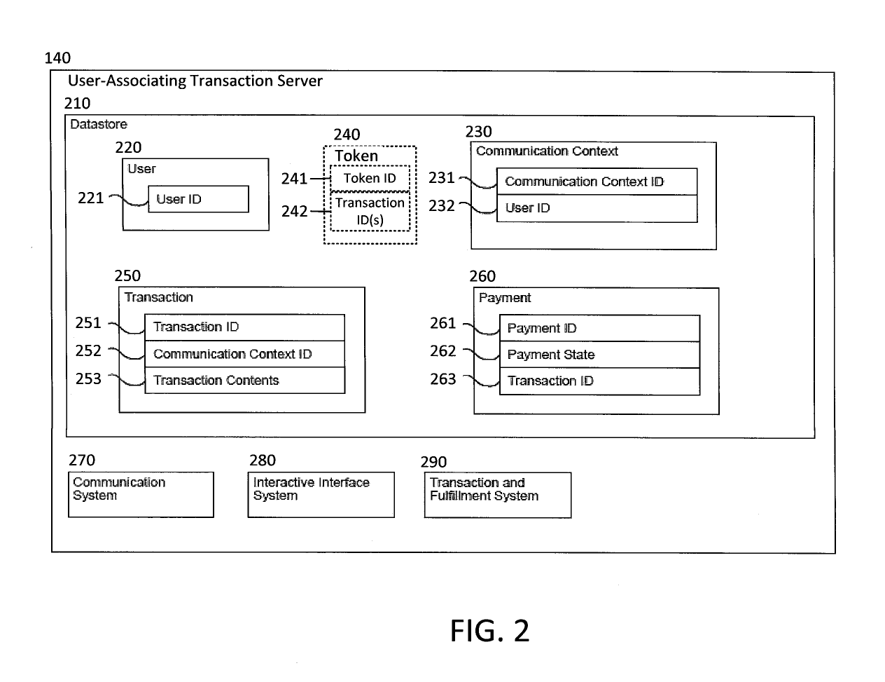

In one implementation, the client software application implements a user interface system (111) that is capable of rendering user interfaces to the user and of accepting and processing user input. The client software application implements a transport (112) that can communicate with the user-associating transaction server (140), which is described in more detail in FIG. 2, over a network (120), such as the Internet, using one or more protocols, such as TCP/IP, HTTP, HTTPS, XMPP, etc. The transport can authenticate the user-associating transaction server using a variety of methods, such as the authentication methods defined in the Transport Layer Security protocol. The client software application also hosts the identity (113) of its user and can provide this to the user-associating transaction server.

One or more remote users may run recipient client software applications (110′) on their computers. Each recipient client software application (110′) may have the same components (111, 112, and 113) as the client software application (110). In one implementation, the client software application (110) and the recipient client software application (110′) may be instances of the same application. Alternatively, they may be different applications, each having the depicted components (111, 112, and 113).

As described herein, the system (100) of FIG. 1 may be used within electronic commerce systems. In one exemplary embodiment, the business may have an in-store system (130). The in-store system may include an identity system (131) for establishing the identity of an in-store user who is requesting fulfillment for transactions, a retrieval system (132) for obtaining fulfillment instructions from the user-associating transaction server, an output system (133) for manifesting or displaying fulfillment instructions in the store, and a user interface system (134) for enabling an employee of the business to interact during the fulfillment process.

FIG. 2 shows components of a user-associating transaction server (140) in accordance with an embodiment of the invention. In the implementation depicted in FIG. 2, the user-associating transaction server (140) includes a communication system (270) that enables users to exchange messages with each other via interfaces in the client software applications. In other implementations, the communication system associated with the client software applications might exist outside of the user-associating transaction server. The associated communication system might be SMS/MMS, or an instant messaging system, or a social network platform, or email, or a voice or video connection among the users, or combinations of communication systems.

The user-associating transaction server (140) may further include an interactive interface system (280) that generates, stores, delivers, and manages user interfaces that can be utilized by software client applications. In one implementation, the interactive interface system is used to present user interfaces that enable users to engage in the business activity, such as selecting items for purchase.

The user-associating transaction server (140) may further include a transaction and fulfillment system (290) that manages transactions through their lifecycle. Steps of the lifecycle managed by this system may include: collection of items, purchase of items, authorization of payment for purchased items, settlement of payment, and fulfillment of items.

The user-associating server (140) may further include a datastore (210) that stores various records. These records may include user record data (220), communication context data (230), transaction record data (250), and payment record data (260). Further description of the stored records will be provided in the detailed description below.

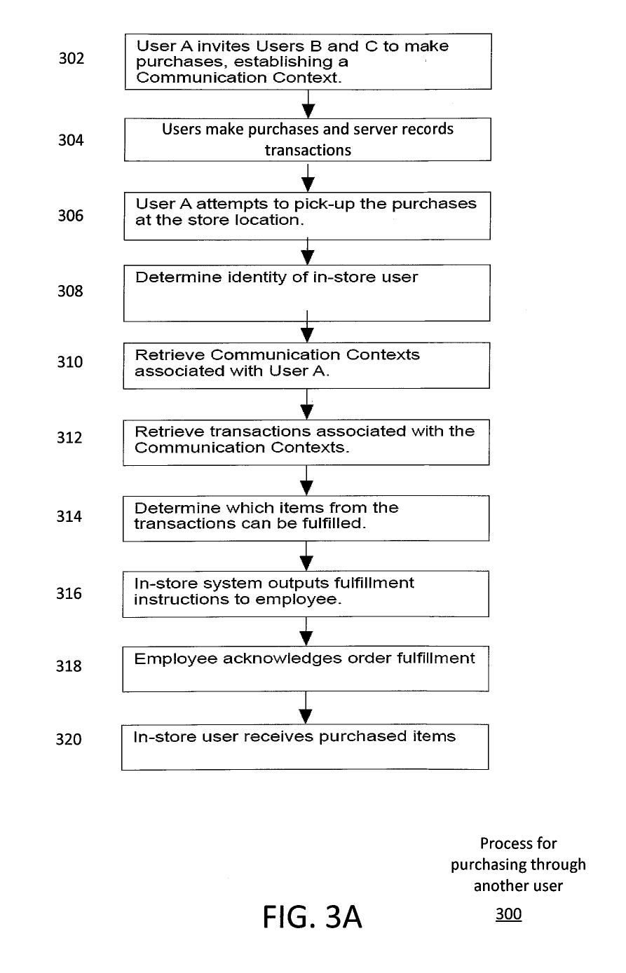

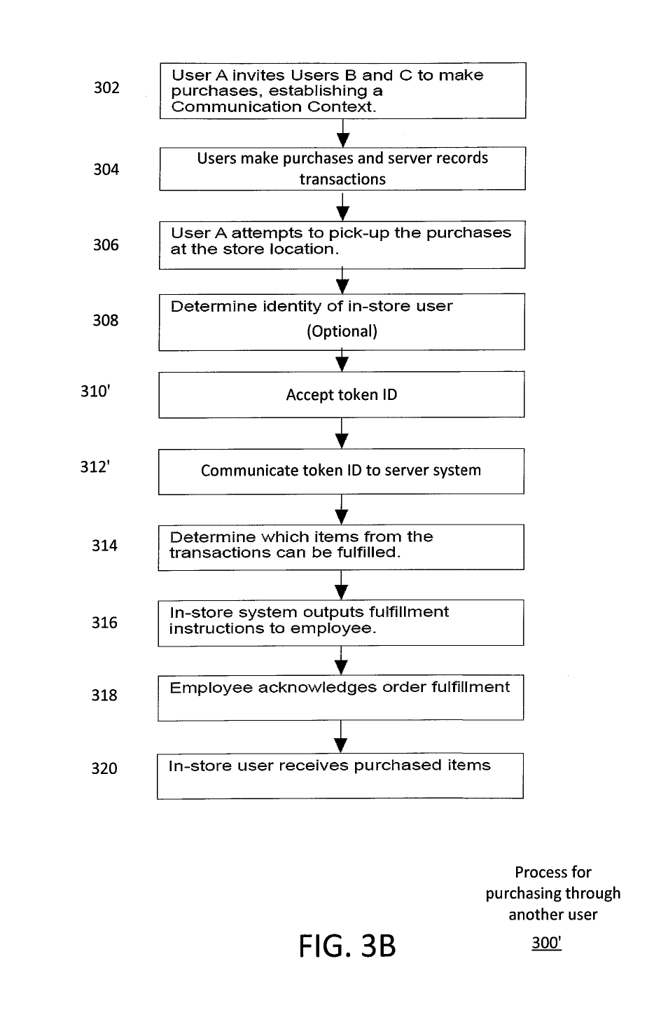

FIG. 3A is a flow diagram that illustrates the steps of an exemplary process (300) for performing a transaction with a business through another user in accordance with an embodiment of the invention. For purposes of discussion, consider a scenario with Users A, B and C. User A is in a physical world store and is using a client software application on his smartphone. Users B and C might not be in the same location as User A, i.e. they may be located remotely from the store.

User A may communicate with one or more other participants, such as users B and C, in this example. User A may use client software application (110), and Users B and C may use recipient client software applications (110′). The client software application (110) of User A and the recipient client applications (110′) of Users B and C may communicate through the user-associating transaction server (140). In this discussion, the user-associating transaction server (140) may be referred to as “the server system”.

In one implementation, shown in step (302), the client software application (110) presents a user interface control to User A that helps the user begin a business activity, such as inviting remote friends or coworkers to buy things from the retailer. User A's invitation of remote friends may establish a communication context which is recorded by the server system. The server system may represent each participant as a user record in the datastore (210). The server system may further associate each participant's user ID (232) with a shared communication context (231) in one or more communication context records (230).

Note that the establishment of the communication context may include creating a new communication context or utilizing a pre-existing communication context. For example, User A may select a communication context that includes a long-running communication thread among Users A, B, and C. Note also that a communication context may be established not by an initial user reaching out to other users, but through alternate means. In one alternate example, an agent of the business could simultaneously send notifications to Users A, B, and C, pulling each user into a shared communication context.

As shown in step (304), participants in the communication context conduct transactions using the interactive interfaces, in this example purchasing items sold by the retailer. The server system may record the transactions as transaction records (250) in its datastore. Each transaction record may have a transaction ID (251) and may associate a set of goods or services being purchased (transaction contents 253) and the shared communication context (communication context ID 252).

Per step (306), fulfillment of the purchases may be subsequently sought. In particular, for example, User A may attempt to pick-up the purchases (including those made by the user and his/her friends) at the store location. For instance, User A may approach an employee of the business and request to pick-up the purchases.

Per step (308), in order to provide User A with the purchased goods and services, the business establishes User A's identity. In one embodiment, the business has in its location an in-store system (130) that is capable of identifying a user via an identification system (131) and communicating with the user-associating transaction server (140) to produce the corresponding user ID (221) in the user record data (220). User identification may be implemented in a variety of ways. For example, an optical scanning device may be connected to the in-store system, which is capable of reading a bar code displayed on a smartphone screen. As another example, a near field communication sensor could be connected to the in-store system that is capable of retrieving a unique identifier from the user's device. Additionally, the in-store system may determine the user's identity by examining the user's credit card or driver's license, or by finding the user record that matches the user's name and phone number, or by matching a shared secret presented by the user to the user record to which the shared secret has been assigned.

Once User A's identity has been determined, the in-store system may request fulfillment instructions for User A via its fulfillment system (132). The fulfillment instructions may be obtained by a sequence of steps.

First, per step (310), the user-associating transaction server (140) may use User A's user ID to retrieve those communication context records (230) from its datastore that include User A's user ID. In other words, communication context IDs (231) associated with the user ID (232) may be found.

Second, given this set of communication context records, the user-associating transaction server (140) may next retrieve, per step (312), those transaction records (250) whose communication context IDs (252) match communication contexts IDs in the set. In other words, transaction IDs (251) associated with the communication context IDs (252) may be retrieved. These retrieved transaction IDs indicate the set of transactions for which the user (User A, in this example) is eligible to receive fulfillment.

In one alternate embodiment, instead of using steps (310) and (312), the set of transaction records may be retrieved by the in-store system (130) accepting a unique token ID from the user (i.e. from User A) per step (310′) and communicating the token ID to the user-associating transaction server (140) per step (312′). This alternate process (300′) is depicted in FIG. 3B. Note that, in this process (300′), the step (308) of determining the identity of the in-store user is optional (not required) because the set of transactions may be found using the token ID without the user ID. The token ID may be embodied in various ways. For example, the token ID may comprise a QR code or a passphrase that was previously generated by the user-associating transaction server (140). Token record data (240) in the user-associating transaction server (140) may associate each token ID (241) with one or a set of transaction IDs (242). The token ID may then be issued to the user (e.g., to User A). The user-associating transaction server (140) may use the token ID (241) to retrieve the associated transaction ID(s) (242) from the datastore 210. In the case where a token record includes a single transaction ID (242) associated with the token ID (241), the transaction record (250) with that transaction ID may be retrieved, and the associated communication context ID (252) may be obtained from that transaction record (250). The user-associating transaction server (140) may then retrieve all transaction IDs (251) that are associated with the communication context ID (252). On the other hand, in the case where a token record includes a set of transaction IDs (242) associated with the token ID (241), that set of transaction IDs (242) may include all the transaction IDs (251) that are associated with the communication context ID (252).

Per step (314), once the set of transactions for which User A is eligible to receive fulfillment has been determined, the user-associating transaction server (140) next proceeds with the fulfillment process, starting with determining which items from the set of transactions can be fulfilled. In one implementation, the user-associating transaction server (140) may provide the set of transactions to the fulfillment system. The fulfillment system determines which of the goods and services specified by the transactions are ready to be delivered to User A per step (314). Fulfillment criteria may include, for example, requiring successful payment for the purchased items and ensuring items are available in the store's inventory.

Note that the fulfillment system may have one or more components within the in-store system (130) and one or more components outside the in-store system (130). See, for example, fulfillment system (132) within the in-store system (130) and transaction and fulfillment system (290) outside the in-store system (130).

Per step (316), the in-store system (130) may then use its output system (133) to output the orders so that they can be viewed by an employee in the store. For example, the in-store system (130) may be connected to a printer and may print a description of the purchased items, or it may show the purchased items in a graphical user interface.

If appropriate, the in-store system (130) may also provide an interface (134) that enables an employee to indicate whether or not ordered items have been delivered to User A per step (318). The interface (134) may also enable the employee to modify some or all of the orders. The in-store system (130) may then update the user-associating transaction server (140) to indicate which orders have been fulfilled. Alternatively, instead of the employee using the user interface (134) to indicate fulfillment, the in-store system (130) may update the user-associating transaction server (140) automatically to indicate which orders have been fulfilled.

The employee may then deliver the ordered items to User A per step (320). In some implementations, the order of steps (318) and (320) may be reversed.

In the exemplary embodiment of the invention just discussed, a communication context record (230) is used as the intermediate record to associate User B's transaction and User A. In other embodiments, there may be additional intermediate records that ultimately complete the same association between User B's transaction and User A. It is also possible that a different form of intermediate record, unrelated to the communication context, may be used to associate User B's transaction and User A.

In an alternate embodiment, the user-associating transaction server (140) may make the association between a transaction and the users eligible to receive fulfillment not via an indirect record, like the communication context record, but instead using an explicit list of user identifiers. Alternatively, the user-associating transaction server (140) may establish a session at the beginning of the execution of the business activity. The session may associate a particular instance of a business activity with the communication context. The user-associating transaction server (140) may then map a transaction to the session's unique identifier.

The above-described embodiments involve an employee in some of the fulfillment steps. In an alternate embodiment, the in-store system (130) may produce the ordered goods directly and provide them directly to User A, without involving an employee. For example, Users A and B may have participated in a shared business activity involving the purchase of movie tickets. As described above, User B might have purchased her ticket independently of User A. User A might now present his smartphone device and perhaps the client software application to an in-store system at the movie theater. The in-store system identifies the user, and retrieves information about transactions associated with User A from the server system, as in steps (308) to (312), and determines which items from the transactions can be fulfilled, as in step (314). The information about transactions associated with User A may, in this example, include User B's transaction, as User B is participating in the same communication context as User A, even though the two users have paid for their tickets separately and through independent interfaces. The order retrieval system may then print movie tickets for both User A and User B and provide both tickets to User A.

In other embodiments of this invention, the fulfillment step need not occur within a physical store location. For example, User A may be shopping online and invite Users B and C to contribute online purchases to all be shipped to User A's address. User A may authenticate with the online business via an online interactive interface and be authorized by the business, using the systems previously described, to receive shipments purchased by Users B and C.

In some embodiments of the invention, the user receiving fulfillment may not have previous awareness of all of the items being fulfilled. In one example, User A offers to pick up for User B. User B purchases both an item for herself as well as an item for User A as a gift to thank User A for offering to pick up. In this example, User A remains unaware of the gift purchase until User A authenticates with the business and receives the items for which User A is eligible to receive fulfillment. The business may identify the second purchase from User B as a gift, wrap it in gift wrap paper, and deliver it to User A along with the other items that User A is picking up as part of the fulfillment step.

In another embodiment of the invention, the system may authenticate the user receiving fulfillment via an authentication service, such as those provided by social networks. The system may find the user record to which the identity provided by the authentication service has previously been assigned.

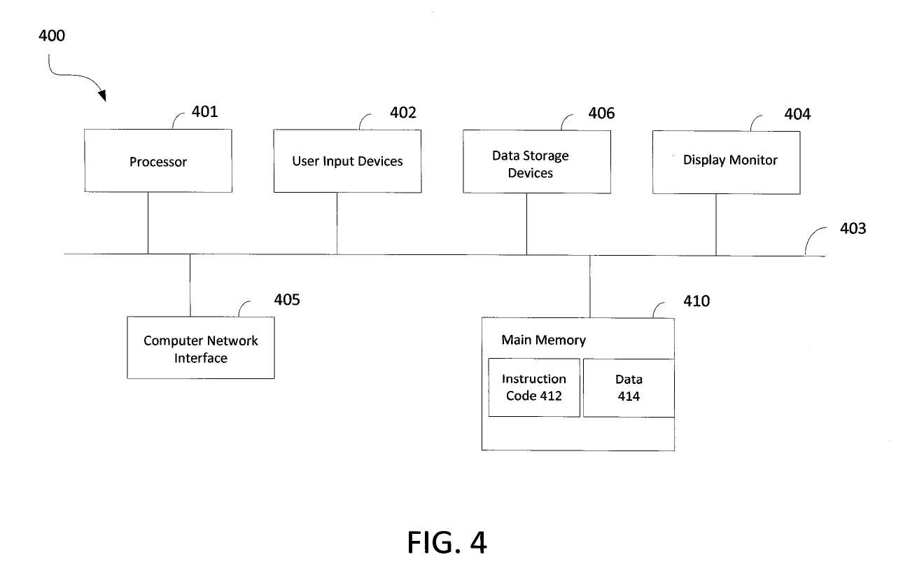

FIG. 4 depicts a simplified example of a computer apparatus (400) in accordance with an embodiment of the invention. This figure shows just one simplified example of such a computer apparatus. A computer apparatus (400) having the illustrated components may be utilized, for example, as client computing devices for executing client computer software applications (110 and/or 110′), as a server computer for use as a user-associating transaction server (140).

As shown, the computer apparatus (400) may include one or more processors (401), such as those from the Intel Corporation of Santa Clara, Calif., for example. The computer apparatus 400 may have one or more buses (403) communicatively interconnecting its various components. The computer apparatus (400) may include one or more user input devices 402 (e.g., keyboard, mouse, etc.), a display monitor (404) (e.g., liquid crystal display, flat panel monitor, etc.), a computer network interface (405) (e.g., network adapter, modem), and a data storage system that may include one or more data storage devices (406) which may store data on a hard drive, semiconductor-based memory, optical disk, or other tangible non-transitory computer-readable storage media, and a main memory (410) which may be implemented using random access memory, for example.

In the example shown in this figure, the main memory (410) includes instruction code (412) and data (414). The instruction code (412) may comprise executable computer-readable program code (i.e., software) components which may be loaded from the tangible non-transitory computer-readable medium of the data storage device (406) to the main memory (410) for execution by the processor(s) (401). In particular, the instruction code (412) may be programmed to cause the computer apparatus (400) to perform the steps described herein.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of fulfilling a purchase of one or more goods or services through another user, the method comprising:
establishing a communication context between first and second users using instances of a client software application on electronic computing devices by a user-associating transaction server;
recording, at the user-associating transaction server, a transaction for a purchase of a first item by the first user; and
determining that the first item is authorized to be fulfilled to the second user due to the established communication context between the first and second users.

2. The method of claim 1, wherein establishing the communication context comprises:
generating and storing records in a datastore for the user-associating transaction server, wherein the records associate the communication context with identifiers of the first and second users in the communication context.

3. The method of claim 1, wherein recording the transaction comprises:
generating and storing transaction records in a datastore for the user-associating transaction server, wherein the transaction records associate the communication context with an identifier for the item.

4. The method of claim 1, wherein determining that the first item is authorized to be fulfilled to the second user comprises:
determining a user identifier for the second user.

5. The method of claim 4, wherein determining that the first item is authorized to be fulfilled to the second user further comprises:
retrieving a communication context identifier associated with the user identifier of the second user.

6. The method of claim 5, wherein determining that the first item is authorized to be fulfilled to the second user further comprises:
retrieving transaction records associated with the communication context identifier.

7. The method of claim 1 further comprising:
determining that the first item is available for fulfillment at an in-store location; and
generating fulfillment instructions for the first item; and
outputting the fulfillment instructions at the in-store location.

8. The method of claim 7 further comprising:
sending an acknowledgement of order fulfillment for the first item to the user-associating transaction server.

9. The method of claim 1 further comprising:
recording, at the user-associating transaction server, a transaction for a purchase of a second item by the second user;
determining that the first and second items are available for fulfillment at an in-store location; and
generating fulfillment instructions for the first and second items; and
printing the fulfillment instructions at the in-store location.

10. The method of claim 1, wherein the communication context includes further users in addition to the first and second users.

11. A user-associating transaction server comprising:
at least one processor;
a tangible, non-transitory data storage system including memory;
a communication system for interconnecting the at least one processor and the data storage system;
a network interface for communicating with a data network;
computer-readable program code stored in the data storage system for
establishing a communication context between first and second users using instances of a client software application on electronic computing devices and a user-associating transaction server,
recording, at the user-associating transaction server, a transaction for a purchase of a first item by the first user, and
determining that the first item is authorized to be fulfilled to the second user due to the established communication context between the first and second users.

12. The user-associating transaction server of claim 11, wherein establishing the communication context comprises:
generating and storing records in a datastore for the user-associating transaction server, wherein the records associate the communication context with identifiers of the first and second users in the communication context.

13. The user-associating transaction server of claim 11, wherein recording the transaction comprises:
generating and storing transaction records in a datastore for the user-associating transaction server, wherein the transaction records associate the communication context with an identifier for the item.

14. The user-associating transaction server of claim 11, wherein determining that the first item is authorized to be fulfilled to the second user comprises:
determining a user identifier for the second user;
retrieving a communication context identifier associated with the user identifier of the second user; and
retrieving transaction records associated with the communication context identifier.

15. A system of fulfilling a purchase of one or more goods or services through another user, the system comprising:
a plurality of mobile communication devices executing instances of a client software application; and
a user-associating transaction server for communicating with the instance of the client software application by way of a data communications network, the server comprising
at least one processor,
a tangible, non-transitory data storage system including memory,
a communication system for interconnecting the at least one processor and the data storage system,
a network interface for communicating with the data communication network,
computer-readable program code stored in the data storage system for
establishing a communication context between first and second users using instances of a client software application on electronic computing devices by a user-associating transaction server,
recording, at the user-associating transaction server, a transaction for a purchase of a first item by the first user, and
determining that the first item is authorized to be fulfilled to the second user due to the established communication context between the first and second users.

16. A method of recording a transaction conducted via an electronic computer interface and authorizing fulfillment of items associated with the transaction, where the items associated with the transaction include reserved or purchased goods or services, the method comprising:
recording on a server system a record of a transaction by an original user;
associating, with the record of the transaction, a set of users authorized to receive fulfillment of the items associated with the transaction, the set of users including at least one user who is different from the original user;
authenticating a receiving user who is a member of the set of users but is different from the original user and who is attempting to receive fulfillment of one or more of the items associated with the transaction;
identifying transactions that are associated with the set of users; and
authorizing fulfillment of the one or more of the items to the receiving user.

17. The method of claim 16, wherein the record of the transaction identifies the set of users directly with user identifiers of the users in the set.

18. The method of claim 16, wherein the record of the transaction identifies the set of users by using a communication context identifier that is associated with user identifiers of the users in the set.

19. The method of claim 16, wherein the fulfillment occurs within a retail business physical location.

20. The method of claim 16, wherein the fulfillment occurs by shipping the one or more items to an address specified by a user in the set of users.

21. The method of claim 16, wherein the transaction is conducted on a mobile electronic communication device.
